(19) United States
(12) Patent Application Publication
(10) Pub. No.: US 2019/0204156 A1
(43) Pub. Date: Jul. 4, 2019

(54) Measurement Data Management System, Measurement Data Management Method, And Optical Characteristic Measurement Device

(71) Applicant: KONICA MINOLTA, INC., Chiyoda-ku (JP)

(72) Inventor: Takuya MATSUMOTO, Toyokawa-sh (JP)

(21) Appl. No.: 16/333,942

(22) PCT Filed: Sep. 14, 2017
(86) PCT No.: PCT/JP2017/033230

§ 371 Date: Mar. 15, 2019

(30) Foreign Application Priority Data
Sep. 21, 2016 (JP) 2016-183664

(51) Int. Cl. G01J 3/52; G01J 3/46

(52) U.S. Cl. CPC G01J 3/524; G01J 3/462

(57) ABSTRACT

A measurement data management system includes a first storage processing unit which makes a first storage unit store diagnosis information obtained by examining a state of an optical characteristic measurement device, a second storage processing unit which make a second storage unit store measurement data obtained by measuring prescribed optical characteristics of an object of measurement by using the optical characteristic measurement device in association with the diagnosis information, and an output unit which outputs the diagnosis information which has been associated with the measurement data and stored in the first storage unit when outputting the measurement data stored in the second storage unit.

### TECHNICAL FIELD

The present invention relates to a technique for managing measurement data obtained by measuring prescribed optical characteristics of an object of measurement by using an optical characteristic measurement device.

### BACKGROUND ART

The optical characteristic measurement device is a device which measures optical characteristics (for example, color and luminance) of the object of measurement (for example, display screen). To guarantee reliability of data (referred to as measurement data below) indicating the optical characteristics of the object of measurement obtained by this measurement, it is necessary to guarantee reliability of the optical characteristic measurement device.

As a technique related to this, Patent Literature 1 discloses a system which guarantees reliability of inspection data. This system includes a measuring instrument which inspects a product and generates the inspection data, an inspection data input terminal which receives an input of the inspection data when an expiration date of calibration of the measuring instrument is not expired in a state where the measuring instrument is used in a normal usage environment, transmits the inspection data to an inspection data management device, and invalidates the input of the inspection data when the expiration date of the calibration is expired, and the inspection data management device which accumulates the transmitted inspection data.

According to the technique of Patent Literature 1, if the expiration date of the calibration of the measuring instrument is expired, the input of the inspection data (in other words, measurement data) is invalidated. The reliability of the inspection data is guaranteed in this way. If the reliability of the measurement data can be guaranteed by using information other than the expiration date of the calibration of the optical characteristic measurement device, options of the information used to guarantee the reliability of the measurement data increase.

### CITATION LIST

### Patent Literature

Patent Literature 1: JP 2006-338552 A

### SUMMARY OF INVENTION

An object of the present invention is to provide a measurement data management system, a measurement data management method, and an optical characteristic measurement device capable of guaranteeing reliability of measurement data by using information other than an expiration date of calibration of the optical characteristic measurement device.

To achieve the above object, the measurement data management system according to one aspect of the present invention includes a first storage unit, a first storage processing unit, a second storage unit, a second storage processing unit, and an output unit. The first storage processing unit makes the first storage unit store diagnosis information obtained by examining a state of an optical characteristic measurement device regarding prescribed items. The second storage processing unit makes the second storage unit store measurement data obtained by measuring prescribed optical characteristics of an object of measurement by using the optical characteristic measurement device in association with the diagnosis information. The output unit outputs the diagnosis information which has been associated with the measurement data and stored in the first storage unit when outputting the measurement data stored in the second storage unit.

Advantages and features provided by one or more embodiments of the invention are fully understood from detailed description below and accompanying drawings. The detailed description and the accompanying drawings are given only as examples and are not intended as a definition to limit the present invention.

### BRIEF DESCRIPTION OF DRAWINGS

FIG. 1 is a block diagram of a configuration of a measurement data management system according to an embodiment.

FIG. 2 is an explanatory diagram for explaining an exemplary configuration of diagnosis information.

FIG. 3 is an explanatory diagram for explaining an example of diagnosis information stored in a diagnosis information storage unit.

FIG. 4 is an explanatory diagram for explaining an example of measurement data stored in a measurement data storage unit.

FIG. 5 is a flowchart for explaining an operation related to creation of a diagnosis program.

FIG. 6 is a flowchart for explaining an operation related to generation of a storage region of the measurement data.

FIG. 7 is a flowchart for explaining an operation related to execution of the diagnosis program.

FIG. 8 is an explanatory diagram for explaining an operation related to storage of the measurement data.

FIG. 9 is a flowchart for explaining an operation relating to reading of the measurement data.

FIG. 10 is an explanatory diagram for explaining a list image displayed on a display unit.

### DESCRIPTION OF EMBODIMENTS

With the technique of Patent Literature 1, in a case where the expiration date of the calibration of the measuring instrument is expired, the reliability of the measurement data cannot be guaranteed until the measuring instrument is calibrated. The inventor of the present invention has found that there is a case where diagnosis information of an optical characteristic measurement device indicates a result such that the optical characteristic measurement device has reliability even when the expiration date of the calibration of the measuring instrument is expired and has created the present invention.

One or more embodiments of the present invention will be described below with reference to the drawings. However, the scope of the invention is not limited to the disclosed embodiments. In the drawings, components denoted with the same reference numeral indicate that the components have the same configuration, and description of a content regarding the component which has been already made is omitted. Here, in a case of being collectively called, the components are indicated by a reference numeral of which a suffix is omitted, and in a case where an individual component is indicated, the component is indicated by a reference numeral with a suffix.

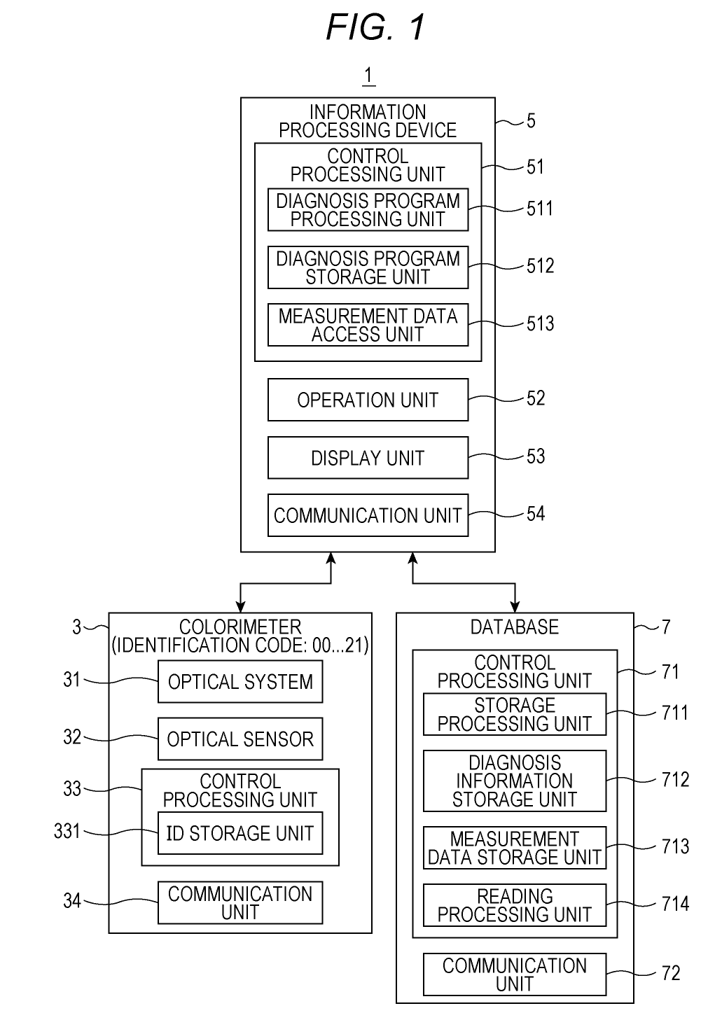

FIG. 1 is a block diagram of a configuration of a measurement data management system 1 according to an embodiment. The measurement data management system 1 includes a colorimeter 3, an information processing device 5, and a database 7. The information processing device 5 and the colorimeter 3 can communicate with each other via wired (for example, Universal Serial Bus (USB) cable) or wireless (for example, Bluetooth (registered trademark)) communication. The information processing device 5 and the database 7 can communicate with each other via a network (for example, Internet and intranet).

The colorimeter 3 is an example of an optical characteristic measurement device. The optical characteristic measurement device is a device which measures optical characteristics of an object of measurement (for example, display screen) by using an optical sensor 32. As the optical characteristic measurement device, for example, a color difference meter, a luminance meter, and a gloss meter can be used, in addition to the colorimeter 3.

A program for diagnosing the colorimeter 3 by examining a state of the colorimeter 3 regarding a prescribed item is referred to as a diagnosis program herein. Note that the program can be restated as a project. In this case, the diagnosis program is restated as a diagnosis project. Diagnosis of the colorimeter 3 is different from calibration of the colorimeter 3. The calibration is to adjust the colorimeter 3 so that the colorimeter 3 has a prescribed performance. The diagnosis is to examine a current performance of the colorimeter 3.

There are a plurality of items, and the items include, for example, reproducibility and repeatability. The reproducibility of the colorimeter 3 is a difference between a measured value obtained when a color of an object to be a reference (for example, a standard-colored color tile) is measured by the colorimeter 3 first and a measured value obtained when the color of the object is measured by the same colorimeter 3 at this time. When this difference is small, the reproducibility is good, and if the difference is large, the reproducibility is poor.

The repeatability of the colorimeter 3 is a value indicating a degree of variation of the measured values when the color of the object to be the reference is repeatedly measured by the colorimeter 3 in a short time. When the degree of the variation is small, the repeatability is good, and the degree of the variation is large, the repeatability is poor.

Here, as the items, the reproducibility and the repeatability will be described as an example. In addition to these, a light quantity of a light source, a wavelength shift, a life of the light source, and a life of a shutter, and the like are used as the items.

The item of the light quantity of the light source is an item used to evaluate a degree of reduction in the maximum value of the light quantity of the light source regarding the light source used by the colorimeter 3.

The item of the wavelength shift is an item used to evaluate a wavelength shift of the colorimeter 3 by observing a chronological change of spectral distribution of a color of a green tile measured by the colorimeter 3. The green tile is one of standard-colored color tiles. Since a range of a change of the spectral distribution of the green color is wider than that of spectral distribution of a red color and spectral distribution of a blue color, the wavelength shift can be evaluated. When the colorimeter 3 is a spectral colorimeter which disperses light by a diffracting grating or a spectral filter and a light source of the spectral colorimeter has an emission line spectrum, the wavelength shift of the colorimeter 3 can be evaluated by evaluating a shift of an emission line.

The item of the life of the light source is an item used to evaluate the life of the light source based on the number of times of light emission of the light source.

The item of the life of the shutter is an item to evaluate a life of a mechanical shutter based on the number of times of use of the mechanical shutter in a case where the colorimeter 3 includes the mechanical shutter.

The diagnosis program is created for each colorimeter 3. This is because the item of the diagnosis program may be different for each colorimeter 3. For example, in a case of a colorimeter, the items of the diagnosis program are the reproducibility and the repeatability, and in a case of another colorimeter, the items of the diagnosis program are the reproducibility, the repeatability, and the light quantity of the light source. Therefore, the single colorimeter 3 is illustrated in FIG. 1. However, the plurality of colorimeters 3 is included.

The plurality of colorimeters 3 can be distinguished from each other. In the embodiment, the plurality of colorimeters 3 is identified by using an identification code (product number) of the colorimeter 3 as an example. However, the method of identification is not limited to this. For example, a user may identify the plurality of colorimeters 3 by applying a unique name to each of the plurality of colorimeters 3. For example, the colorimeters 3 are identified by naming 100 colorimeters as the first colorimeter to the 100th colorimeter.

The colorimeter 3 includes an optical system 31, the optical sensor 32, a control processing unit 33, and a communication unit 34. The optical system 31 guides light emitted or reflected from the object of measurement to the optical sensor 32. The optical sensor 32 receives the light and converts the light into an electric signal. The electric signal is transmitted to the control processing unit 33. The control processing unit 33 calculates a value of a color of the object of measurement by using the electric signal. In addition to this calculation function, the control processing unit 33 performs control and processing necessary for executing a function of the colorimeter 3.

The control processing unit 33 is realized, for example, by hardware such as a central processing unit (CPU), a random access memory (RAM), a read only memory (ROM), a hard disk drive (HDD), and the like and a program, data, and the like to execute the function of the control processing unit 33. Regarding the function of the control processing unit 33, a part or all of each function may be realized by processing by a Digital Signal Processor (DSP) instead of or together with the processing by the CPU. Furthermore, similarly, a part or all of the function of the control processing unit 33 may be realized by processing by a dedicated hardware circuit instead of or together with processing by software. The description above is similarly applied to control processing units 51 and 71 to be described later.

The control processing unit 33 includes an ID storage unit 331 as a functional block. The ID storage unit 331 stores an ID allocated to the diagnosis program. The ID can be restated as a unique ID. The ID storage unit 331 is realized by a nonvolatile memory and the like.

The communication unit 34 has a function for communicating with other device (here, information processing device 5). The communication unit 34 is realized by a communication interface.

The information processing device 5 is a personal computer and includes a control processing unit 51, an operation unit 52, a display unit 53, and a communication unit 54. The control processing unit 51 performs control and processing necessary for executing the functions of the information processing device 5.

The control processing unit 51 includes a diagnosis program processing unit 511, a diagnosis program storage unit 512, and a measurement data access unit 513 as functional blocks.

The diagnosis program processing unit 511 (example of creation unit) performs processing necessary for creating the diagnosis program and executing the diagnosis program. That is, the diagnosis program processing unit 511 creates the diagnosis program for each colorimeter 3 and makes the diagnosis program storage unit 512 (example of third storage unit) store the created diagnosis program. By executing the diagnosis program, the diagnosis program processing unit 511 diagnoses the colorimeter 3 and creates diagnosis information.

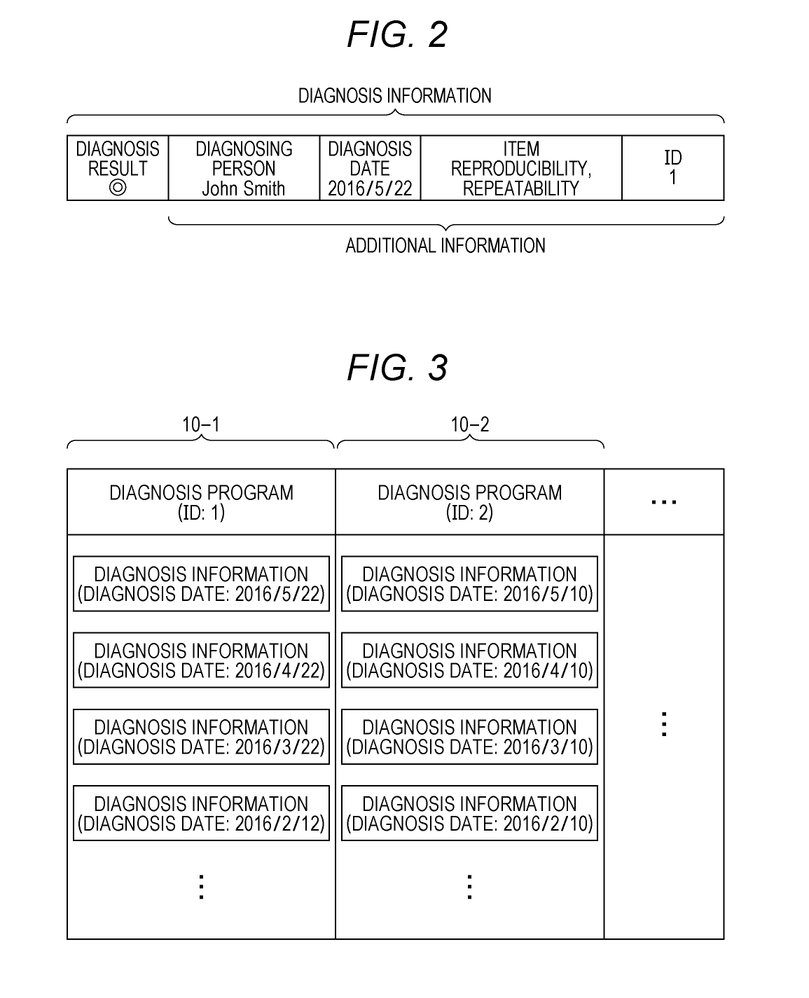

The diagnosis information will be described. The diagnosis information is information obtained by examining a state of the colorimeter 3 (optical characteristic measurement device) regarding a prescribed item. FIG. 2 is an explanatory diagram for explaining an example of a configuration of the diagnosis information. The diagnosis information includes a diagnosis result and additional information.

The diagnosis result is comprehensive evaluation of the colorimeter 3 determined based on evaluation on the plurality of items regarding the colorimeter 3. In the diagnosis result, reliability of the colorimeter 3 is indicated by a plurality of levels. It is assumed that the reliability be indicated by three stages. For example, when the reliability is extremely high, the diagnosis result is indicated by a symbol “⊙”, and when the reliability is high, the diagnosis result is indicated by a symbol “∘”. When the reliability is not high, the diagnosis result is indicated by a symbol “Δ”. These are examples of the expression of the diagnosis result, and other expressions can be used.

The additional information includes a diagnosing person, a diagnosis date, an item, and an ID (unique ID). The diagnosing person is a user who has diagnosed the colorimeter 3 (that is, user who makes information processing device 5 diagnose colorimeter 3). The diagnosis date is a date (date and time) when the information processing device 5 has diagnosed the colorimeter 3. The diagnosis may be regularly executed (for example, daily, weekly, monthly) or may be irregularly executed. The items are as described above. The ID (unique ID) is an ID allocated to the diagnosis program as described later.

The additional information is not limited to this. For example, a date when the colorimeter 3 is calibrated, a result of measurement system analysis (MSA) diagnosis, the reliability of the measurement data are included in the additional information. The measurement data is data obtained by measuring the color of the object of measurement by using the colorimeter 3 (data indicating value of color of object of measurement). The reliability of the measurement data is reliability of measurement data obtained by measuring the object of measurement by using the colorimeter 3 which has been diagnosed by the diagnosis program. For example, in a case where the diagnosis result of the colorimeter 3 is “⊙”, the reliability of the measurement data is “A”, in a case where the diagnosis result of the colorimeter 3 is “∘”, the reliability of the measurement data is “B”, and in a case where the diagnosis result of the colorimeter 3 is “Δ”, the reliability of the measurement data is “C”.

With reference to FIG. 1, the measurement data access unit 513 executes processing necessary for accessing the measurement data accumulated in the database 7.

The operation unit 52 (example of first input unit and second input unit) is a device to input instructions, data, and the like to the information processing device 5 by the user. The operation unit 52 is realized by a keyboard, a mouse, a touch panel, and the like. The display unit 53 is a device which displays an image, a screen, and the like generated by the control processing unit 51. The display unit 53 is realized by a liquid crystal display, an organic Electro Luminescence (EL) display, and the like. The control processing unit 51 and the display unit 53 function as an output unit. When outputting the measurement data, the output unit outputs diagnosis information associated with the measurement data.

The communication unit 54 has a function for communicating with other devices (here, colorimeter 3 and database 7). The communication unit 54 is realized by a communication interface.

The database 7 accumulates the diagnosis information and the measurement data. The database 7 includes the control processing unit 71 and a communication unit 72. The control processing unit 71 performs control and processing necessary for executing a function of the database 7.

The control processing unit 71 includes a storage processing unit 711, a diagnosis information storage unit 712, a measurement data storage unit 713, and a reading processing unit 714 as functional blocks.

The storage processing unit 711 (example of first storage processing unit and second storage processing unit) executes processing for associating the measurement data transmitted from the information processing device 5 with the diagnosis information and making the measurement data storage unit 713 (example of second storage unit) store the associated data and information. The storage processing unit 711 executes processing for making the diagnosis information storage unit 712 (example of first storage unit) store the diagnosis information transmitted from the information processing device 5.

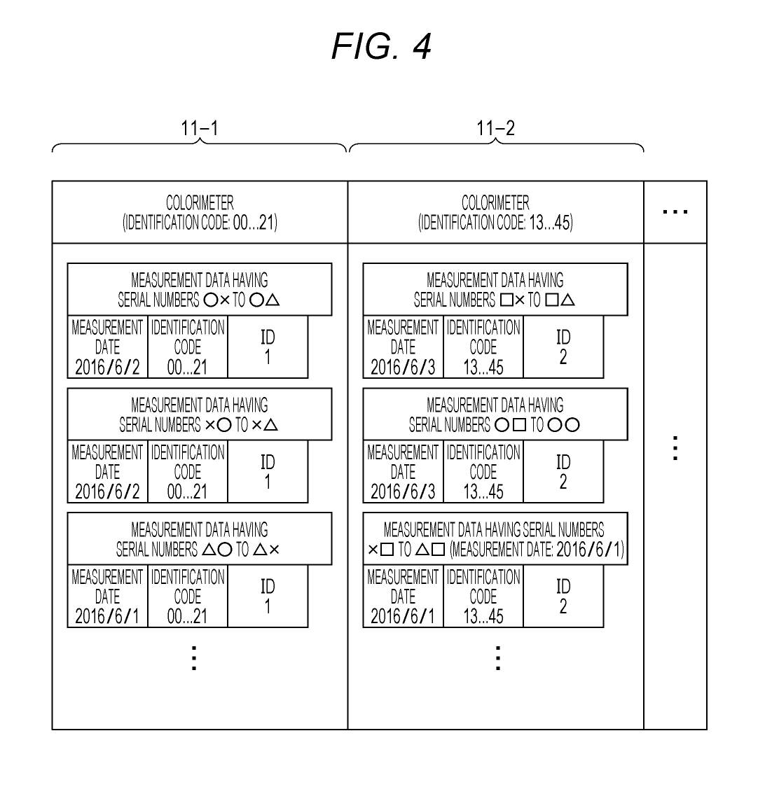

FIG. 3 is an explanatory diagram for explaining an example of the diagnosis information stored in the diagnosis information storage unit 712. FIG. 4 is an explanatory diagram for explaining an example of the measurement data stored in the measurement data storage unit 713. With reference to FIG. 3, the diagnosis information storage unit 712 includes a plurality of storage regions 10 including storage regions 10-1 and 10-2. The storage region 10-1 stores diagnosis information obtained by executing a diagnosis program of which the ID is “1”. The ID “1” is an ID allocated to the diagnosis program for the colorimeter 3 illustrated in FIG. 1. The ID storage unit 331 of the colorimeter 3 stores “1” as the ID. The storage region 10-2 stores diagnosis information obtained by executing a diagnosis program of which the ID is “2”. The ID “2” is an ID allocated to a diagnosis program for a colorimeter 3 (not shown) different from the colorimeter 3 illustrated in FIG. 1. In FIG. 2, the storage regions 10 other than the storage regions 10-1 and 10-2 are omitted.

With reference to FIG. 4, the measurement data storage unit 713 includes a plurality of storage regions 11 including storage regions 11-1 and 11-2. The storage region 11-1 stores measurement data obtained by measuring the object of measurement by the colorimeters 3 having the identification code “00 . . . 21”. The colorimeter 3 is the colorimeter 3 which stores “1” as the ID (colorimeter 3 illustrated in FIG. 1). The storage region 11-2 stores measurement data obtained by measuring the object of measurement by a colorimeter 3 having an identification code “13 . . . 45” (not shown). The colorimeter is a colorimeter 3 (not shown) which stores “2” as the ID. In FIG. 4, the storage regions 11 other than the storage regions 11-1 and 11-2 are omitted.

With reference to FIG. 1, the reading processing unit 714 executes processing for reading the measurement data stored in the measurement data storage unit 713 and transmitting the read data to the information processing device 5 and executes processing for reading the diagnosis information stored in the diagnosis information storage unit 712 and transmitting the read data to the information processing device 5.

The communication unit 72 has a function for communicating with other device (here, information processing device 5). The communication unit 72 is realized by a communication interface.

The operations of the measurement data management system 1 according to the embodiment include (1) an operation related to creation of the diagnosis program, (2) an operation related to generation of the storage region of the measurement data, (3) an operation related to execution of the diagnosis program, (4) an operation related to storage of the measurement data, and (5) an operation related to reading of the measurement data.

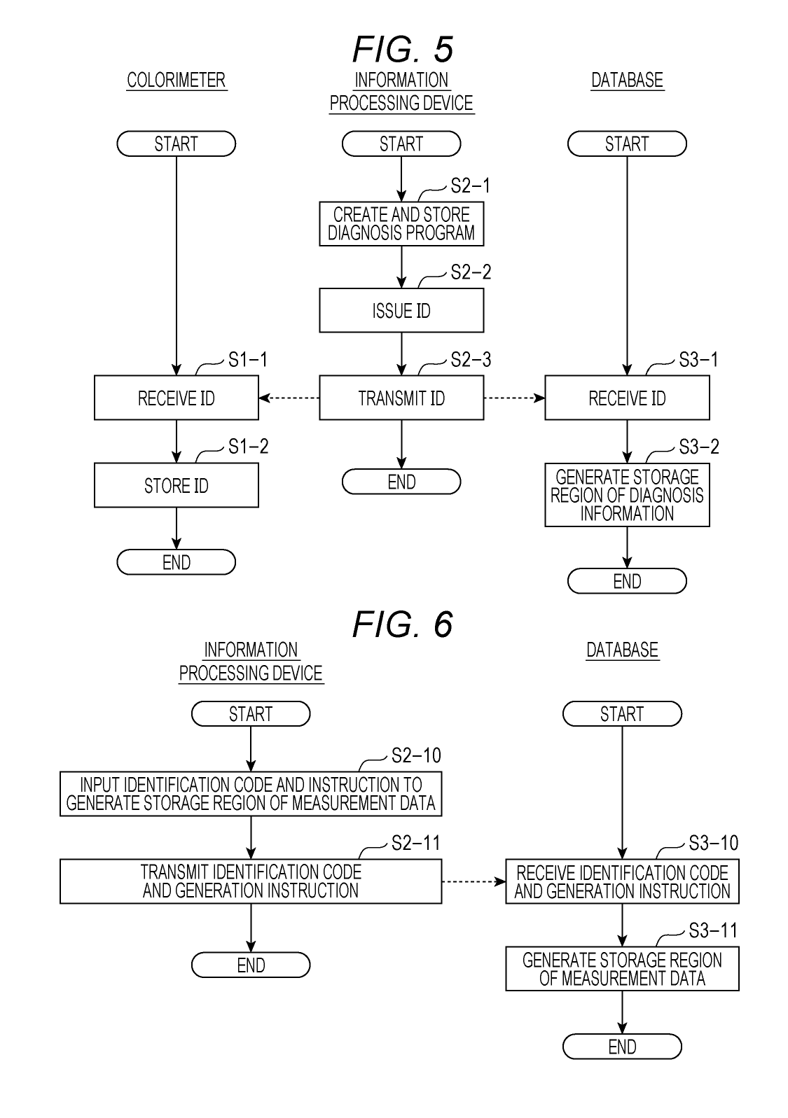

First, the operation related to the creation of the diagnosis program will be described. FIG. 5 is a flowchart for explaining this operation. With reference to FIGS. 1 and 5, the diagnosis program processing unit 511 stores a template of the diagnosis program in advance which is completed by inputting the item. An item input screen (not shown) is displayed on the display unit 53 of the information processing device 5, and the user operates the operation unit 52 to input the identification code of the colorimeter 3 to be diagnosed and the item applied to the diagnosis. Here, it is assumed that the identification code “00 . . . 21” of the colorimeter 3 illustrated in FIG. 1 be input and the reproducibility and the repeatability be input as the items. The diagnosis program processing unit 511 creates a diagnosis program having the items of the reproducibility and the repeatability and makes the diagnosis program storage unit 512 store the diagnosis program in association with the identification code “00 . . . 21” (step S2-1).

As described above, since the diagnosis program is created for each colorimeter 3, the diagnosis program storage unit 512 stores the plurality of diagnosis programs respectively allocated to the plurality of colorimeters 3 in advance.

The diagnosis program processing unit 511 issues an ID allocated to the diagnosis program created in step S2-1 (step S2-2). Here, it is assumed that “1” is issued as the ID. The diagnosis program processing unit 511 instructs to transmit the issued ID to the colorimeter 3. The communication unit 54 of the information processing device 5 transmits the ID to the colorimeter 3 and the database 7 based on the instruction (step S2-3).

The communication unit 34 of the colorimeter 3 receives the ID transmitted in step S2-3 (step S1-1). The control processing unit 33 makes the ID storage unit 331 store the ID received in step S1-1 (step S1-2). Here, the ID storage unit 331 stores “1”.

The communication unit 72 of the database 7 receives the ID transmitted in step S2-3 (step S3-1). The control processing unit 71 generates the storage region 10 associated with the ID received in step S3-1 in the diagnosis information storage unit 712 (step S3-2). Here, the storage region 10-1 (FIG. 3) associated with the ID “1” is generated. At the time when the storage region 10-1 is generated, the diagnosis information is not stored in the storage region 10-1 yet. In step S2-3, the communication unit 54 of the information processing device 5 may transmit the input identification code to the database 7 together with the ID. In this case, the control processing unit 71 generates the storage region 10-1 associated with the identification code “00 . . . 21” and the ID “1”.

The operation related to the generation of the storage region of the measurement data will be described. FIG. 6 is a flowchart for explaining this operation. With reference to FIGS. 1 and 6, the user operates the operation unit 52 of the information processing device 5, inputs the identification code of the colorimeter 3, and inputs an instruction to generate the storage region of the measurement data (step S2-10). Here, as the identification code, the identification code “00 . . . 21” of the colorimeter 3 illustrated in FIG. 1 is input. The control processing unit 51 instructs to transmit the identification code and the generation instruction input in step S2-10 to the database 7. Based on this, the communication unit 54 transmits the identification code and the generation instruction to the database 7 (step S2-11).

The communication unit 72 of the database 7 receives the identification code and the generation instruction transmitted in step S2-11 (step S3-10). The control processing unit 71 generates the storage region 11 associated with the identification code which has been received in step S3-10 in the measurement data storage unit 713 (step S3-11). Here, the storage region 11-1 (FIG. 4) associated with the identification code “00 . . . 21” is generated. At the time when the storage region 11-1 is generated, the measurement data is not stored in the storage region 11-1 yet.

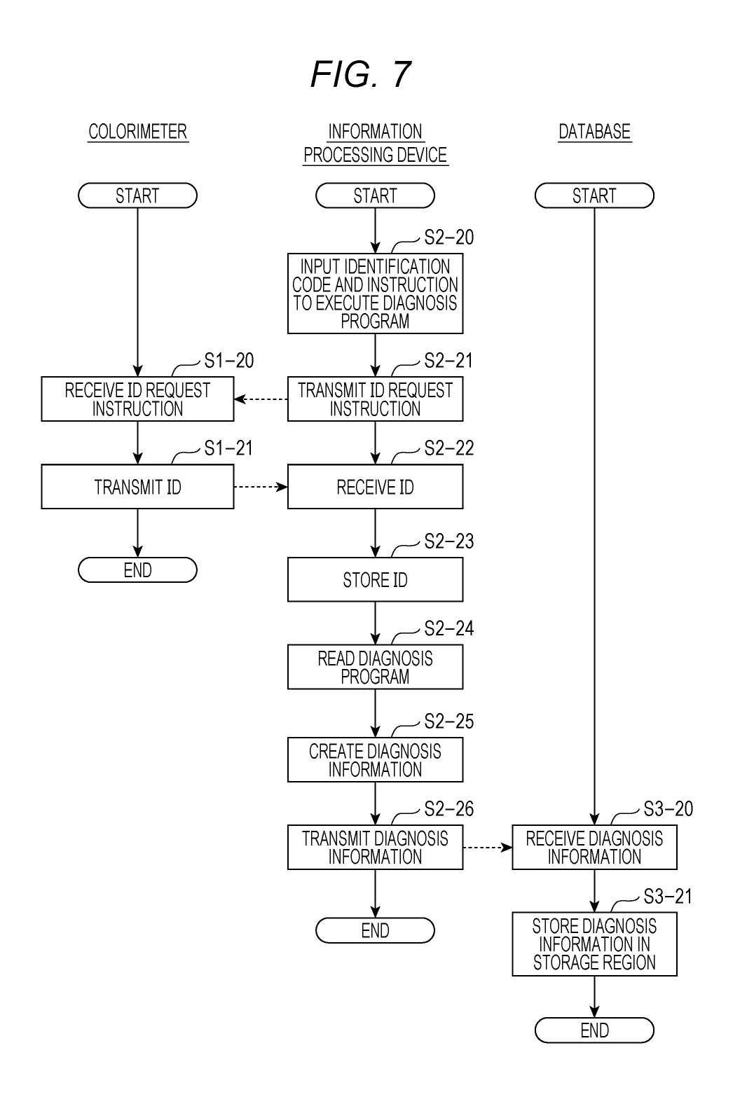

The operation related to the execution of the diagnosis program will be described. FIG. 7 is a flowchart for explaining this operation. With reference to FIGS. 1 and 7, the user operates the operation unit 52 of the information processing device 5, inputs the diagnosing person, the diagnosis date, and the identification code of the colorimeter 3 to be diagnosed to the information processing device 5, and inputs an instruction to execute the diagnosis program to the information processing device 5 (step S2-20). The diagnosis program processing unit 511 executes processing for obtaining the ID and processing for reading the diagnosis program. The processing for obtaining the ID will be described. The diagnosis program processing unit 511 issues an instruction for requesting the ID to the colorimeter 3. Based on this, the communication unit 54 transmits the ID request instruction to the colorimeter 3 (step S2-21).

The communication unit 34 of the colorimeter 3 receives the request instruction transmitted in step S2-21 (step S1-20). The control processing unit 33 reads the ID “1” stored in the ID storage unit 331 and instructs to transmit the ID to the information processing device 5. Based on this, the communication unit 34 transmits the ID “1” to the information processing device 5 (step S1-21).

The communication unit 54 of the information processing device 5 receives the ID “1” transmitted in step S1-21 (step S2-22). The diagnosis project processing unit stores the ID “1” received in this step (step S2-23).

The processing for reading the diagnosis program will be described. The diagnosis program processing unit 511 reads a diagnosis program associated with the identification code input in step S2-20 from the diagnosis program storage unit 512 (step S2-24). Then, the diagnosis program processing unit 511 stands by.

The diagnosis program processing unit 511 executes the diagnosis program read in step S2-24 and creates the diagnosis information of the colorimeter 3 (step S2-25). That is, when the operation unit 52 (first input unit) is operated and an instruction to diagnose the colorimeter 3 designated from among the plurality of colorimeters 3 is input, the diagnosis program processing unit 511 reads the diagnosis program allocated to the designated colorimeter 3 from the diagnosis program storage unit 512 (third storage unit), executes the read diagnosis program, examines the state of the designated colorimeter 3, and creates the diagnosis information. This will be specifically described below.

The user operates the operation unit 52 and inputs a reproducibility measurement instruction to the information processing device 5 so that the diagnosis program processing unit 511 controls the colorimeter 3 to measure the reproducibility of the colorimeter 3. Next, the user operates the operation unit 52 and inputs a repeatability measurement instruction to the information processing device 5 so that the diagnosis program processing unit 511 controls the colorimeter 3 to measure the repeatability of the colorimeter 3.

An example will be described in which the information processing device 5 controls the colorimeter 3 and measures the reproducibility of the repeatability of the colorimeter 3. The present invention is not limited to this, and it is possible that the user operates the colorimeter 3 and measures the reproducibility and the repeatability of the colorimeter 3.

The diagnosis program processing unit 511 levels the measured value of the reproducibility and the value of the reproducibility measured by a prescribed threshold. It is assumed that the level of the reproducibility is indicated by three stages. For example, when the reproducibility is extremely good, the level of the reproducibility is indicated by a symbol “⊙”, when the reproducibility is good, the level of the reproducibility is indicated by a symbol “∘”, and when the reproducibility is not good, the level of the reproducibility is indicated by a symbol “Δ”.

The diagnosis program processing unit 511 levels the measured value of the repeatability similarly to the reproducibility.

The diagnosis program processing unit 511 obtains the diagnosis result of the colorimeter 3 based on the level of the reproducibility and the level of the repeatability. For example, when both of the level of the reproducibility and the level of the repeatability are “⊙”, the diagnosis result is “⊙”, when at least one of the level of the reproducibility or the level of the repeatability is “Δ”, the diagnosis result is “Δ”, and a case except for these cases, the diagnosis result is “∘”.

The diagnosis program processing unit 511 generates diagnosis information including the diagnosis result. As explained in FIG. 2, the diagnosis information includes the diagnosis result and the additional information. The diagnosing person and the diagnosis date included in the additional information are respectively the diagnosing person and the diagnosis date input in step S2-20. The ID included in the additional information is the ID stored in step S2-23.

The creation of the diagnosis information has been described above.

The diagnosis program processing unit 511 instructs to transmit the diagnosis information created in step S2-25 to the database 7. Based on this, the communication unit 54 transmits the diagnosis information created in step S2-25 to the database 7 (step S2-26).

The communication unit 72 of the database 7 receives the diagnosis information transmitted in step S2-26 (step S3-20). The storage processing unit 711 refers to the ID included in the diagnosis information received in step S3-20 and stores the diagnosis information in the storage region 10 associated with this ID (step S3-21). Here, the diagnosis information is stored in the storage region 10-1 illustrated in FIG. 3.

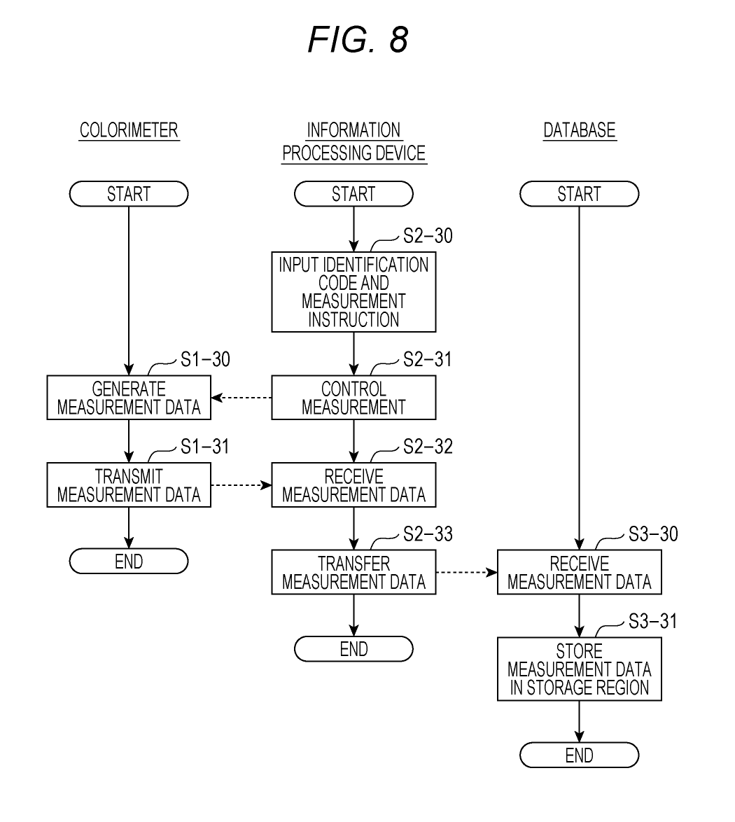

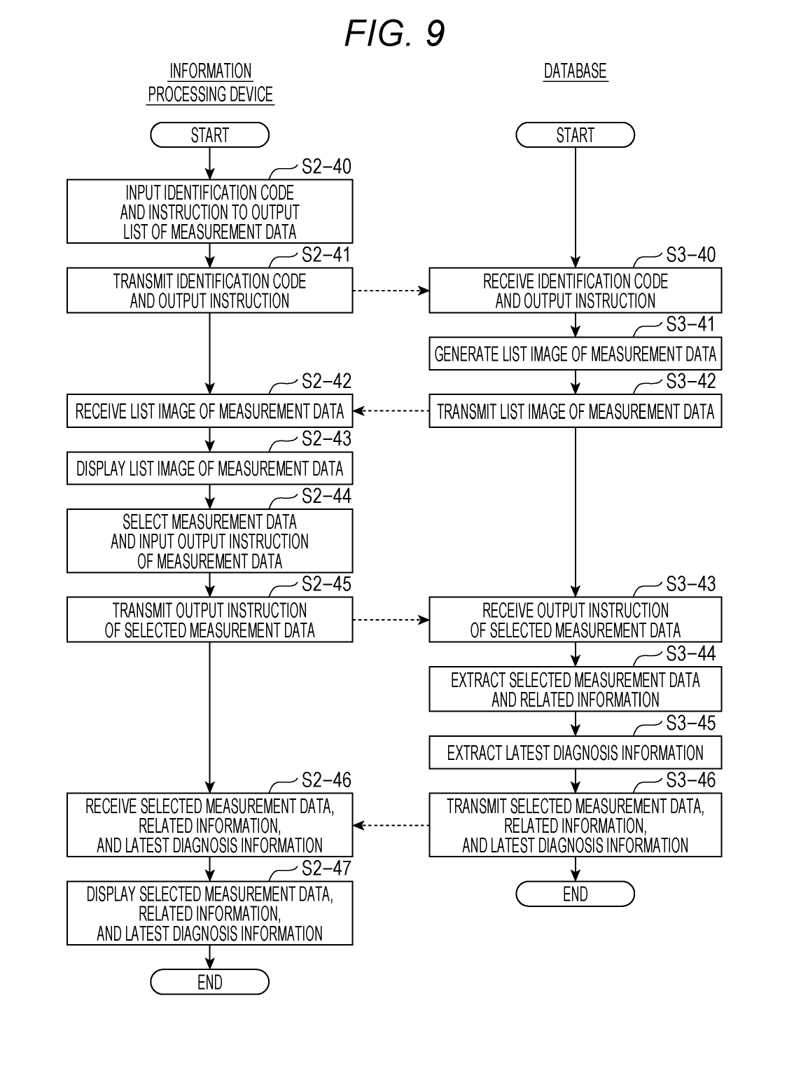

The operation related to the storage of the measurement data will be described. FIG. 8 is an explanatory diagram for explaining this operation. With reference to FIGS. 1 and 8, the user operates the operation unit 52 of the information processing device 5, inputs the identification code of the colorimeter 3 used to measure the color of the object of measurement to the information processing device 5, and inputs an instruction to execute the color measurement to the information processing device 5 (step S2-30). Here, it is assumed that the colorimeter 3 illustrated in FIG. 1 be used. Therefore, the identification code is “00 . . . 21”.

The information processing device 5 controls the colorimeter 3 (step S2-31), makes the colorimeter 3 measure a value of the color of the object of measurement and generate measurement data indicating the value (step S1-30). The control processing unit 33 of the colorimeter 3 adds related information of the measurement data to the measurement data. The related information includes a measurement date, the identification code of the colorimeter 3, the ID stored in the ID storage unit 331, and the like. Here, the identification code is “00 . . . 21”, and the ID is “1”. The control processing unit 33 instructs to transmit the measurement data to which the related information is added to the information processing device 5. Based on this, the communication unit 34 transmits the measurement data to which the related information is added to the information processing device 5 (step S1-31).

The communication unit 54 receives the measurement data to which the related information is added and which has been transmitted in step S1-31 (step S2-32). The control processing unit 51 instructs to transfer the measurement data to which the related information is added and which has been received in step S2-32 to the database 7. Based on this, the communication unit 54 transfers the measurement data to which the related information is added to the database 7 (step S2-33).

The communication unit 72 of the database 7 receives the measurement data to which the related information is added and which has been transferred in step S2-33 (step S3-30). The storage processing unit 711 refers to the identification code included in the related information in the measurement data to which the related information is added and which has been received in step S3-30 and stores the measurement data to which the related information is added in the storage region 11 associated with the identification code (step S3-31). Here, the measurement data to which the related information is added is stored in the storage region 11-1 illustrated in FIG. 4.

The operation related to the reading of the measurement data will be described. FIG. 9 is a flowchart for explaining this operation. With reference to FIGS. 1 and 9, a case where the measurement data obtained by measuring the object of measurement is read by using the colorimeter 3 illustrated in FIG. 1 will be described as an example. The user operates the operation unit 52 of the information processing device 5, inputs the identification code “00 . . . 21” of the colorimeter 3 to the information processing device 5, and inputs an instruction to output a list of the measurement data to the information processing device 5 (step S2-40).

The measurement data access unit 513 instructs to transmit the identification code input in step S2-40 and the output instruction to the database 7. Based on this, the communication unit 54 transmits the identification code and the output instruction to the database 7 (step S2-41).

The communication unit 72 of the database 7 receives the identification code and the output instruction transmitted in step S2-41 (step S3-40). The reading processing unit 714 generates a list image indicating a list of the measurement data stored in the storage region 11 (here, storage region 11-1) associated with the identification code received in step S3-40 (step S3-41). The reading processing unit 714 instructs to transmit the list image generated in step S3-41 to the information processing device 5. Based on this, the communication unit 72 transmits the list image generated in step S3-41 to the information processing device 5 (step S3-42).

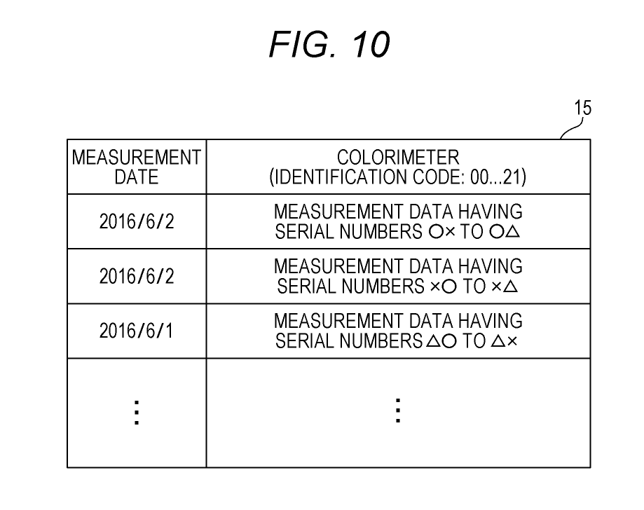

The communication unit 54 of the information processing device 5 receives the list image transmitted in step S3-42 (step S2-42). The control processing unit 51 makes the display unit 53 display the list image received in step S2-42 (step S2-43). FIG. 10 is an explanatory diagram for explaining an example of a list image 15 displayed on the display unit 53.

For example, in a case where it is desired to output measurement data having serial numbers ∘x to ∘Δ, the user operates the operation unit 52, designates a character image “measurement data having the serial numbers ∘x to ∘Δ” included in the list image 15, and inputs a measurement data output instruction to the information processing device 5 (step S2-44). The control processing unit 51 instructs to transmit the output instruction input in step S2-44 to the database 7. Based on this, the communication unit 54 transmits the output instruction input in step S2-44 to the database 7 (step S2-45).

The communication unit 72 of the database 7 receives the output instruction transmitted in step S2-45 (step S3-43). The reading processing unit 714 accesses the measurement data to be a target of the output instruction received in step S3-43 (that is, measurement data selected in step S2-44) and extracts the measurement data (measurement data having serial numbers ∘x to ∘Δ) and the related information added to the measurement data (measurement date, identification code, ID, and the like) from the storage region 11-1 (step S3-44).

The reading processing unit 714 refers to the ID included in the related information extracted in step S3-44 and accesses the storage region 10 associated with the ID (here, storage region 10-1 in FIG. 3). Then, the reading processing unit 714 extracts the latest diagnosis information (here, diagnosis information dated on May 22, 2016) of the diagnosis information stored in the storage region 10-1 from the storage region 10-1 (step S3-45).

The reading processing unit 714 instructs to transmit the measurement data and the related information extracted in step S3-44 and the latest diagnosis information extracted in step S3-45 to the information processing device 5. The reading processing unit 714 may execute processing for deleting the ID included in the related information of the measurement data and the ID included in the latest diagnosis information from the transmission target. This is because it is not particularly necessary for the user to know the IDs.

The communication unit 72 transmits the measurement data and the related information extracted in step S3-44 and the latest diagnosis information extracted in step S3-45 to the information processing device 5 (step S3-46).

The communication unit 54 of the information processing device 5 receives the measurement data, the related information, and the latest diagnosis information transmitted in step S3-46 (step S2-46). The control processing unit 51 makes the display unit 53 display the measurement data, the related information, and the latest diagnosis information received in step S2-46 (step S2-47).

When the colorimeter 3 measures the color of the object of measurement (that is, when measurement data is obtained in step S2-32 in FIG. 8), the control processing unit 51 may make the display unit 53 display the diagnosis information. The measurement data access unit 513 accesses the storage region 10-1 of the database 7 based on the ID of the colorimeter 3 and obtains the latest diagnosis information from the storage region 10-1. The control processing unit 51 makes the display unit 53 display the latest diagnosis information.

In step S2-47 in FIG. 9, a mode in which the measurement data, the related information, and the latest diagnosis information are displayed on the display unit 53 is one mode of these outputs. The control processing unit 51 and the display unit 53 function as an output unit. When outputting the measurement data stored in the measurement data storage unit 713 (second storage unit), the output unit outputs the diagnosis information which has been associated with the measurement data and stored in the diagnosis information storage unit 712 (first storage unit).

The control processing unit 51 and the display unit 53 have been described as output units. However, a printing unit (not shown) may serve as an output unit. The printing unit prints the measurement data together with the diagnosis information. This printed matter is an inspection slip (inspection report) of the object of measurement.

There are varies scenes where colorimetric data is output. The following two examples will be described. The value of the color of the object of measurement measured by the colorimeter 3 is within a standard. However, when the color of the object of measurement is visually inspected, there is a case where an abnormality in the color is found. In this situation, the user can confirm the reliability of the colorimeter 3 by viewing the measurement data and the diagnosis information together.

Another example is a scene in which a plurality of components is assembled and a finished product is produced. Specifically, in the assembly industry, an assembly manufacturer purchases a plurality of components from a component manufacturer and assembles a product (finished product) by using these components. For the assembly manufacturer, management of a color of the component configuring an appearance of the product is important. The assembly manufacturer needs to compare a color expressed by a first component and a color expressed by a second component regarding the first component (for example, liquid crystal panel) and the second component (for example, outer frame) configuring the product. At this time, it is desired to quantify and compare the colors. Therefore, measurement data of the color of the first component is compared with measurement data of the color of the second component. At this time, to confirm the reliability of the measurement data, the user views the diagnosis information and confirms the reliability of the colorimeter 3.

Main effects of the embodiment will be described. According to the embodiment, at the time when the measurement data is output, the diagnosis information of the colorimeter 3 is output (step S2-47 in FIG. 9). Therefore, the reliability of the measurement data can be guaranteed by using information other than expiration date of the calibration of the colorimeter 3.

Since the diagnosis information indicates the reliability of the colorimeter 3, the user can use the diagnosis information as an example when validating the measurement data.

In a case where the colorimeter 3 stores a repair history and a calibration history of the colorimeter 3, it is possible to associate the measurement data with the repair history and the calibration history, in addition to the diagnosis information.

With reference to FIGS. 1 and 4, the related information stored in the measurement data storage unit 713, in addition to the measurement date, the identification code, and the ID, at least one of a measuring person, a temperature of a measuring place, and a humidity of the measuring place at the time when the colorimeter 3 measures the color of the object of measurement. This is because these elements affect the result of the measurement data.

The first modification to the third modification according to the embodiment will be described. Although the embodiment is the measurement data management system, the first modification is a colorimeter (optical characteristic measurement device) including a measurement data management system. In the first modification, a colorimeter 3 includes a diagnosis program processing unit 511, a diagnosis program storage unit 512, a measurement data access unit 513, an operation unit 52, a display unit 53, a storage processing unit 711, a diagnosis information storage unit 712, a measurement data storage unit 713, and a reading processing unit 714 illustrated in FIG. 1. In a case where a data amount of diagnosis information is small (for example, in a case where diagnosis information only includes diagnosis result), even if a capacity of a memory of the colorimeter 3 is not large, the colorimeter 3 can include the measurement data management system.

The second modification will be described. The second modification can output a history of diagnosis information. As described in step S3-2 in FIG. 5, a control processing unit 71 can generate a storage region 10-1 associated with an identification code “00 . . . 21” and an ID “1”. In the second modification, a storage region 10 is associated with an identification code and an ID in each of a plurality of storage regions 10 illustrated in FIG. 3.

The history of the diagnosis information related to a colorimeter 3 illustrated in FIG. 1 will be described as an example. A user operates an operation unit 52 of an information processing device 5 (example of second input unit), inputs the identification code “00 . . . 21” of the colorimeter 3 to the information processing device 5, and inputs an instruction to output the history of the diagnosis information to the information processing device 5. A control processing unit 51 accesses the storage region 10-1 of a database 7 based on the identification code of the colorimeter 3 and obtains all diagnosis information stored in the storage region 10-1. The control processing unit 51 makes a display unit 53 display all the diagnosis information.

The third modification will be described. In the embodiment, as illustrated in FIG. 1, diagnosis information and measurement data are accumulated in a single database 7. In the third modification, the number of databases 7 is not one. The diagnosis information is accumulated in a single database, and the measurement data is accumulated in another database.

### Summary of Embodiment

A measurement data management system according to one aspect of the embodiment includes a first storage unit, a first storage processing unit which makes the first storage unit store diagnosis information obtained by examining a state of an optical characteristic measurement device regarding prescribed items, a second storage unit, a second storage processing unit which makes the second storage unit store measurement data obtained by measuring prescribed optical characteristics of an object of measurement by using the optical characteristic measurement device in association with the diagnosis information, and an output unit which outputs the diagnosis information which has been associated with the measurement data and stored in the first storage unit when outputting the measurement data stored in the second storage unit.

The diagnosis of the optical characteristic measurement device is different from calibration of the optical characteristic measurement device. The diagnosis means to examine the state (performance) of the optical characteristic device at the time of diagnosis. According to the measurement data management system according to the first aspect of the embodiment, the diagnosis information of the optical characteristic measurement device is output when the measurement data is output. Therefore, the reliability of the measurement data can be guaranteed by using information other than an expiration date of calibration of the optical characteristic measurement device.

As an output, the measurement data and the diagnosis information may be displayed on a display unit or may be printed.

In the above configuration, the first storage unit stores the plurality of pieces of diagnosis information obtained by examining the state of the optical characteristic measurement device at different timings, and the output unit outputs the latest diagnosis information of the plurality of pieces of the diagnosis information.

When the optical characteristic measurement device is regularly or irregularly diagnosed a plurality of times, the first storage unit stores the plurality of pieces of diagnosis information. According to this configuration, the latest diagnosis information can be output.

In the above configuration, to the measurement data stored in the second storage unit, at least one of a measuring person, a temperature of a measuring place, and a humidity of the measuring place at the time when the optical characteristic measurement device measures prescribed optical characteristics of the object of measurement is added.

Since the measuring person, the temperature of the measuring place, and the humidity of the measuring place affect a result of the measurement data, at least one of them is added to the measurement data.

The above configuration further includes a third storage unit which stores a plurality of diagnosis programs respectively allocated to the plurality of optical characteristic measurement devices in advance, a first input unit, and a creation unit which reads the diagnosis program allocated to the designated optical characteristic measurement device from the third storage unit when the first input unit is operated and an instruction to diagnose the designated optical characteristic measurement device from among the plurality of optical characteristic measurement devices is input, executes the read diagnosis program, examines the state of the designated optical characteristic measurement device, and creates the diagnosis information.

This configuration is applied to a case where a content (item) of the diagnosis program is different for each of the plurality of optical characteristic measurement devices.

The above configuration further includes a second input unit, and when the second input unit is operated and an instruction to output the plurality of pieces of diagnosis information is input, the output unit outputs the plurality of pieces of diagnosis information stored in the first storage unit.

According to the above configuration, since the plurality of pieces of diagnosis information is output, the user can recognize a history of the diagnosis information.

A measurement data management method according to a second aspect of the embodiment includes a first step of making a first storage unit store diagnosis information obtained by examining a state of an optical characteristic measurement device regarding prescribed items, a second step of making a second storage unit store measurement data obtained by measuring prescribed optical characteristics of an object of measurement by using the optical characteristic measurement device in association with the diagnosis information, and a third step of outputting the diagnosis information which has been associated with the measurement data and stored in the first storage unit when outputting the measurement data stored in the second storage unit.

The measurement data management method according to the second aspect of the embodiment prescribes the measurement data management system according to the first aspect of the embodiment from the viewpoint of the method and has similar action and effect to the first aspect of the embodiment.

An optical characteristic measurement device according to a third aspect of the embodiment which is an optical characteristic measurement device for measuring optical characteristics of an object of measurement and includes a first storage unit, a first storage processing unit which makes the first storage unit store diagnosis information obtained by examining a state of the optical characteristic measurement device regarding prescribed items, a second storage unit, a second storage processing unit which makes the second storage unit store measurement data obtained by measuring prescribed optical characteristics of the object of measurement by using the optical characteristic measurement device in association with the diagnosis information, and an output unit which outputs the diagnosis information which has been associated with the measurement data and stored in the first storage unit when outputting the measurement data stored in the second storage unit.

The optical characteristic measurement device according to the third aspect of the embodiment includes the measurement data management system according to the first aspect of the embodiment and has similar action and effect to the first aspect of the embodiment.

The embodiment of the present invention has been illustrated and described in detail. However, the illustrations and examples are merely examples and do not limit the present invention. The scope of the present invention should be interpreted according to the language of the appended claims.

Japanese patent application No. 2016-183664 filed on Sep. 21, 2016, including the specification, claims, drawings, and abstract, the entire disclosure of which is hereby incorporated by reference in its entirety.

### INDUSTRIAL APPLICABILITY

According to the present invention, a measurement data management system, a measurement data management method, and an optical characteristic measurement device can be provided.

1. A measurement data management system comprising:
a hardware processor
that:
stores diagnosis information obtained by examining a state of an optical characteristic measurement device regarding prescribed items;
stores measurement data obtained by measuring prescribed optical characteristics of an object of measurement by using the optical characteristic measurement device in association with the diagnosis information; and
outputs the diagnosis information which has been associated with the measurement data and stored in the hardware processor when outputting the measurement data stored in the hardware processor.

2. The measurement data management system according to claim 1, wherein
the hardware processor
stores the plurality of pieces of diagnosis information obtained by examining the state of the optical characteristic measurement device at different timings, and
outputs the latest diagnosis information of the plurality of pieces of the diagnosis information.

3. The measurement data management system according to claim 1, wherein
to the measurement data stored in the hardware processor, at least one of a measuring person, a temperature of a measuring place, and a humidity of the measuring place at the time when the optical characteristic measurement device measures the prescribed optical characteristics of the object of measurement is added.

4. The measurement data management system according to claim 1, further comprising
a first input part, wherein
the hardware processor
stores a plurality of diagnosis programs respectively allocated to the plurality of optical characteristic measurement devices in advance, and
reads the diagnosis program allocated to the designated optical characteristic measurement device from the hardware processor when the first input part is operated and an instruction to diagnose the designated optical characteristic measurement device from among the plurality of optical characteristic measurement devices is input, execute the read diagnosis program, examine a state of the designated optical characteristic measurement device, and create the diagnosis information.

5. The measurement data management system according to claim 2, further comprising
a second input part, wherein
when the second input part is operated and an instruction to output the plurality of pieces of diagnosis information is input, the hardware processor outputs the plurality of pieces of diagnosis information stored in the hardware processor.

6. A measurement data management method comprising:
making a hardware processor store diagnosis information obtained by examining a state of an optical characteristic measurement device regarding prescribed items;
making the hardware processor store measurement data obtained by measuring prescribed optical characteristics of an object of measurement by using the optical characteristic measurement device in association with the diagnosis information; and
outputting the diagnosis information which has been associated with the measurement data and stored in the hardware processor when outputting the measurement data stored in the hardware processor.

7. An optical characteristic measurement device for measuring optical characteristics of an object of measurement, comprising:
a hardware processor
that:
stores diagnosis information obtained by examining a state of an optical characteristic measurement device regarding prescribed items;
store stores measurement data obtained by measuring prescribed optical characteristics of the object of measurement by using the optical characteristic measurement device in association with the diagnosis information; and
outputs the diagnosis information which has been associated with the measurement data and stored in the hardware processor when outputting the measurement data stored in the hardware processor.

8. The measurement data management system according to claim 2, wherein
to the measurement data stored in the hardware processor, at least one of a measuring person, a temperature of a measuring place, and a humidity of the measuring place at the time when the optical characteristic measurement device measures the prescribed optical characteristics of the object of measurement is added.

9. The measurement data management system according to claim 2, further comprising
a first input part, wherein
the hardware processor
stores a plurality of diagnosis programs respectively allocated to the plurality of optical characteristic measurement devices in advance, and
reads the diagnosis program allocated to the designated optical characteristic measurement device from the hardware processor when the first input part is operated and an instruction to diagnose the designated optical characteristic measurement device from among the plurality of optical characteristic measurement devices is input, execute the read diagnosis program, examine a state of the designated optical characteristic measurement device, and create the diagnosis information.

10. The measurement data management system according to claim 3, further comprising
a first input part, wherein
the hardware processor
stores a plurality of diagnosis programs respectively allocated to the plurality of optical characteristic measurement devices in advance, and
reads the diagnosis program allocated to the designated optical characteristic measurement device from the hardware processor when the first input part is operated and an instruction to diagnose the designated optical characteristic measurement device from among the plurality of optical characteristic measurement devices is input, execute the read diagnosis program, examine a state of the designated optical characteristic measurement device, and create the diagnosis information.
